(19) United States
(12) Patent Application Publication
(10) Pub. No.: US 2005/0283400 A1
(43) Pub. Date: Dec. 22, 2005

(54) System and method for delivering consulting services and information technology solutions in a healthcare environment

(76) Inventors: Ivo Nelson, Houston, TX (US); Dana Sellers, Houston, TX (US); Jim Austin, The Woodlands, TX (US)

Correspondence Address: VINSON & ELKINS L.L.P., 1001 FANNIN STREET, 2300 FIRST CITY TOWER, HOUSTON, TX, 77002-6760, US

(21) Appl. No.: 11/126,930

(22) Filed: May 11, 2005

Related U.S. Application Data
(60) Provisional application No. 60/570,726, filed on May 13, 2004.

(51) Int. Cl. G06F 17/00

(52) U.S. Cl. 705/14

(57) ABSTRACT

A method includes identifying and prioritizing goals and objectives for an information technology project in a healthcare environment. A governance group is selected to serve as a decision maker throughout the technology project. The identified and prioritized goals are used as a basis for developing a project plan and deciding upon desired outcomes for the technology project. Predefined process flows are associated with the project plan. Optimal scenarios for the predefined process flows are presented to the governance group at a decision meeting. A process flow is decided upon and the project plan is implemented.

This application claims the benefit of U.S. Provisional Application No. 60/570,726, filed May 13, 2004.

### BACKGROUND OF THE INVENTION

1. Field of the Invention

This invention relates generally to information systems, and, more particularly, to a system and method for delivering consulting services and information technology solutions in a healthcare environment.

2. Description of the Related Art

A number of hospitals, doctor's offices, universities, and other medical facilities (collectively “healthcare environments”) utilize information technology, such as software, hardware, web-based applications, networks, databases, communication systems, data entry and display points, etc., in their operations. Information technology may be used, for example, to assist healthcare environments in certain operational processes, such as data entry for new patients, diagnostics, lab studies, medication administration, out-patient services, supply ordering, and other like processes. These systems have become increasingly prevalent in hospitals. Many different vendors, application providers, and/or consultants currently market software, information systems, and/or consulting services for these processes.

Unfortunately, for healthcare applications, information technology initiatives often fail to live up to their initial expectations and do not deliver tangible business or clinical value. According to a 2001 Gartner study, 30% of all information technology projects never come to a fruitful conclusion. On the average, 51% of these projects exceed budget expectations, while only delivering 74% of the originally stated functionality.

Currently, most healthcare information technology projects are approached from a technology perspective not from a process perspective. In other words, most implementations are technology-centric, rather than process-centric. That is, the focus and planning is placed on the features and functionality of the software being planned, selected, implemented, and/or optimized, rather than the process to be affected. As a result, it is often the case that projects are not successful because they do not deliver the expected benefits, in the expected amount of time, or for the expected amount of money budgeted.

Many new projects fail or do not live up to expectations because of issues with governance, alignment of technology with process, operations, and technology. When delivering new technology, or when optimizing existing technology, most organizations require approval from multiple departments or decision makers before a change in process or technology may be made. Delays are often encountered as proposals for changes and authorizations from decision makers are obtained.

Information technology projects also experience problems because of a lack of understanding as to the underlying processes to be affected by a modification to existing technology or the implementation of new technology. As a result, the system or technology may not align or fit with the way a particular organization carries out its processes. To be more effective, the organization may need to alter its own internal processes, so that it can better utilize available technology. In other words, the problem or inefficiency may not be with the technology but with the process. In addition, many projects are started without considering the metrics to be used to measure the effectiveness of the technology. Without having the ability to compare before and after results, it is difficult, if not impossible, for the organization to accurately determine if the changes made have improved operations or become a hindrance.

To reduce or minimize the adverse impact of unanticipated results, projects are often undertaken using a “phased” approach. In this manner, if the expected benefits or results are not achieved at the completion of a phase, the health care facility can initiate a corrective phase to complete or alter those aspects of the project that were not completed during the original phase. Several initiatives may be necessary before the desired outcome is achieved. As can be expected, this iterative approach to delivering or optimizing information technology may delay projects and at the same time consume valuable resources that could better benefit the organization.

The present invention is directed to overcoming, or at least reducing the effects of, one or more of the problems set forth above.

### SUMMARY OF THE INVENTION

In one aspect of the invention, a method is provided. The method includes identifying and prioritizing goals and objectives for an information technology project in a healthcare environment. A governance group is selected to serve as a decision maker throughout the technology project. The identified and prioritized goals are used as a basis for developing a project plan and deciding upon desired outcomes for the technology project. Predefined process flows are associated with the project plan. Optimal scenarios for the predefined process flows are presented to the governance group at a decision meeting. A process flow is decided upon and the project plan is implemented.

### BRIEF DESCRIPTION OF THE DRAWINGS

The invention may be best understood by reference to the following description taken in conjunction with the accompanying drawings, in which like reference numerals identify like elements, and in which:

FIG. 1 is a simplified flowchart illustrating one exemplary process for strategic planning in accordance with one embodiment of the present invention;

FIG. 2 is a simplified flowchart illustrating one exemplary process for system selection in accordance with one embodiment of the present invention;

FIG. 3 is a simplified flowchart illustrating one exemplary process for system implementation in accordance with one embodiment of the present invention;

FIG. 4 is a simplified flowchart illustrating one exemplary process for system optimization in accordance with one embodiment of the present invention;

FIG. 5 is an exemplary decision meeting presentation used in accordance with the flowcharts illustrated in FIGS. 1-4;

FIG. 6 is another exemplary decision meeting presentation used in accordance with the flowcharts illustrated in FIGS. 1-4;

FIG. 7 illustrates one embodiment of a process flow database; and

FIG. 8 illustrates one embodiment of a metric database.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

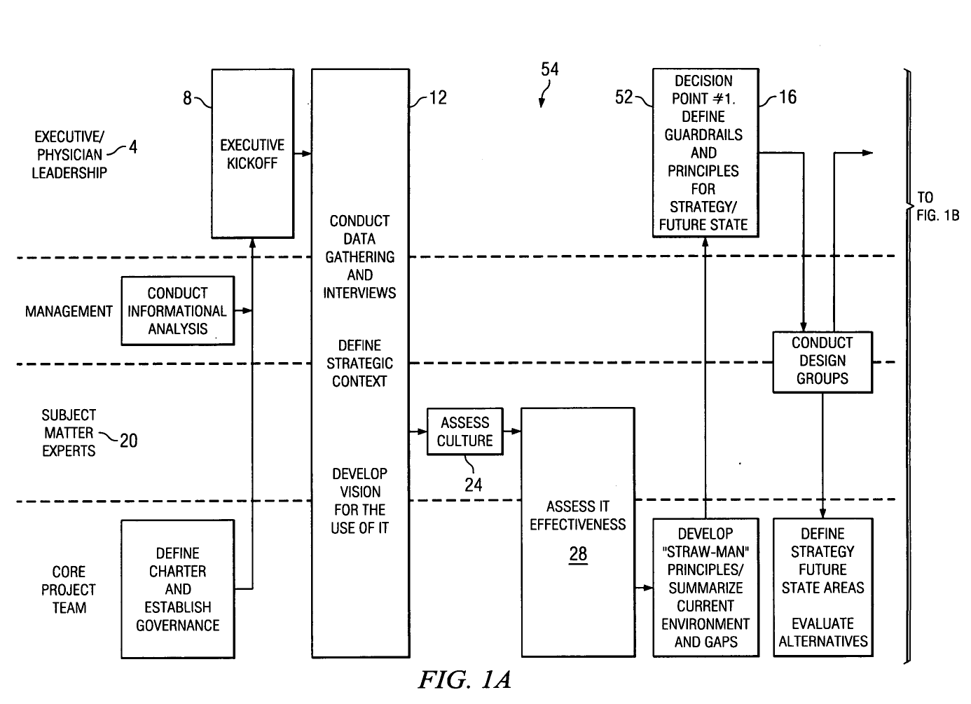

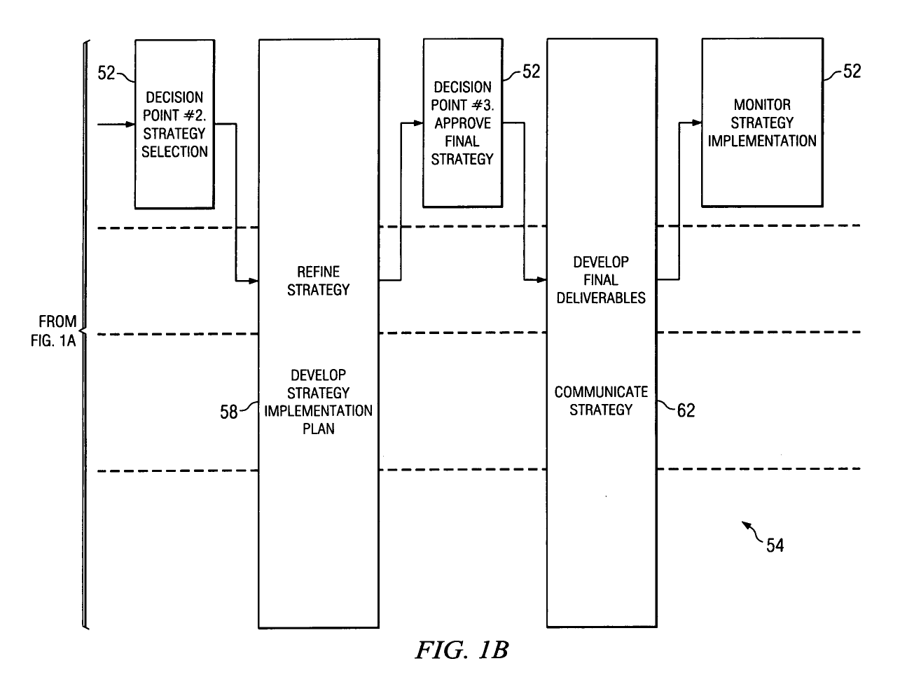

Referring to FIGS. 1-4, flow charts illustrating one embodiment of the present invention are shown. This illustrative process may be used in a healthcare environment to assist entities, such as organizations, individuals, etc., in optimizing their information technology investment, obtain desired outcomes, measure the outcome of a project over time, complete projects in less time and with less costs, implement new technology, and provide a smooth transition to a desired state. To assist in describing the present invention, FIGS. 1-4 are described with reference to implementing or optimizing a process control software application in a healthcare environment. It should be appreciated, however, that the invention is not so limited and that the present invention may be used with any number of different applications or process technologies. For example, the present invention may be used with technology projects to assist with strategic planning, system selection, implementation, and optimization/process redesign. To simplify the present discussion, these different uses shall be referred to generically hereafter as a ‘technology project’.

To more effectively implement change in a healthcare environment, the appropriate people should be assembled and involved in the decision making process at the appropriate times. In this illustrative example, those individuals participating in a technology project are divided into four groups, ‘Executive/physician Leadership’, ‘Management’, ‘Subject Matter Experts’, and ‘Core Project Team’.

In FIGS. 1-4, the processes or steps undertaken by a particular group are organized for ease of illustration by row. For example, in FIG. 1, the Executive/Physician Leadership group 4 participates in processes that are represented by boxes 8, 12, 16, etc., whereas the Subject Matter Experts group 20 participates in processes that are represented by boxes 12, 24, 28, etc. It should be appreciated, however, that any number of different groups may be selected and that the responsibility assignments may vary depending upon the particular technology project.

In one embodiment of the present invention, the focus of a technology project is on the process or methodology to be affected. In other words, a process-centric or process-driven approach is used. In the past, information technology has been paired with healthcare processes without sufficient consideration as to how the two will align. With the present invention, rather than focusing, for example, on the “bells and whistles” of a particular technology, the realization of strategy may depend on an appropriate change to a healthcare process and the understanding that technology provides little value unless it enables more efficient processes. In other words, to maximize information technology value, the overall strategy should also consider changes to healthcare processes that may be necessary to fully take advantage of the efficiencies and improvements a certain technology is intended to offer.

At or near the outset of a technology project, a governance group is selected. The governance group is involved in and makes key business decisions before processes are changed, technology is deployed, or optimized. In the examples illustrated in FIGS. 1-4, the governance group includes the Executive Physician Leadership group 4.

The governance group may include a representative group of individuals working in a particular healthcare environment. For example, the governance group may include doctors, administrators, representatives from various departments (e.g., nursing, accounting, etc.), or other high level personnel working in a healthcare environment. In general, decision makers are individuals having authority to make decisions that affect the operations of a healthcare environment, and the selection of the governance group should attempt to represent as many levels as possible within an organization.

At selected points throughout a technology project, the governance group is called upon to participate in “decision meetings” to facilitate decision making for the technology project. The term decision meeting is intended to denote a period or point in time in which decision makers across various levels of an organization are gathered to make decisions about a particular technology project. In essence, the decision meetings provide a structured way to effectively communicate, at one time, with the decision makers in an organization. For example, during a decision meeting, the governance group may be presented with a number of different options that may affect certain processes within the organization. Following the presentation, key business decisions may be presented to the governance group along with the benefits, implications, cost, and cultural change for each. As such, key decisions may be made without holding up the process flow for the technology project.

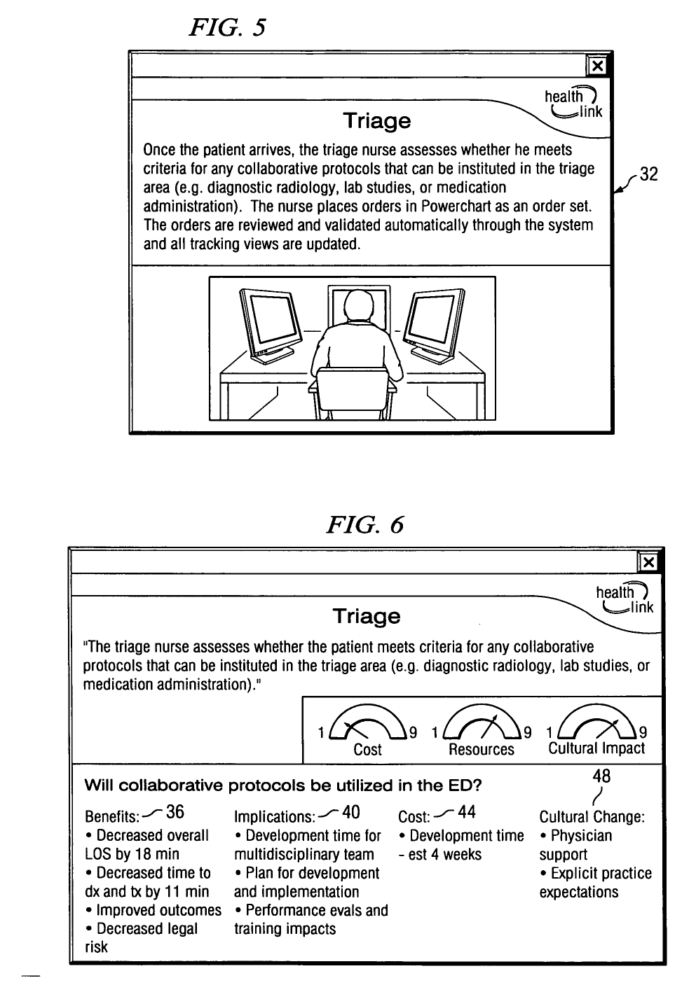

In one embodiment, the decision meeting may include the presentation of optimal scenarios (e.g., presented as stories) as a way of communicating the potential operation of the organization's affected area. For example, referring to FIG. 5, an exemplary decision meeting presentation 32 relating to triage is shown. In this example, the presentation 32 is in the format of an optimal scenario.

In FIG. 6, the benefits 36, implications 40, costs 44, and cultural change 48 for the triage process are presented in the form of a cumulative chart for the decision makers in the governance group to consider. Once the different options are presented to the governance group, a decision may be made with the reassurance of having a representative group of decision makers participating from different levels within than organization.

Decision meetings may be scheduled at selected points throughout a technology project. In the past, projects were delayed while individuals with approval authority were located, meetings were scheduled, and then for the decision to be made. Under this approach, key decision makers are represented in the governance group, and the group is able to quickly make decisions as a cohesive unit, thus allowing the project to move forward.

In FIGS. 1-4, decisions meetings 52 are shown illustrated as decision points. Generally, decision meetings 52 may be planned to coincide with critical events or dates in a technology project. Alternatively, decision meetings may be scheduled on predetermined periodic intervals, thus allowing decision makers to better plan their schedule. In short, the planning and scheduling of a decision meeting 52 may vary depending upon a number of factors, including the type of project, organization, etc.

Referring back to FIG. 1, a strategic planning process 54 in accordance with one embodiment of the present invention is shown. During the strategic planning process 54, a project plan may be formulated that supports the organizational goals and objects of a healthcare environment. The organizational goals are incorporated into the decision making process and operational activities required for the project. The strategic planning process 54 is used to produce a more clear definition and prioritization of an organization's business goals.

In this illustrative example, at block 12, all groups participating in the technology project develop a vision for the use of information technology within the organization. For example, it may be decided that improvements should be made to the insurance processing systems used within the organization. Alternatively, it may be that procedures for admitting a new patient to the emergency room should be improved to reduce patient wait time. One approach is to identify organizational areas where information technology is believed to be capable of delivering the greatest business result. Strategic plans have traditionally been unfocused and included recommendations with little or no business justification.

With the present invention, the strategic planning process 54 includes representatives from different levels within the organization. At block 58, a strategy implementation plan is developed, and at block 62, final deliverables are considered and a communication strategy is decided upon. The communication strategy is intended to convey details about the technology project to other individuals within the organization. As shown, the strategic planning process 54 is interspersed with decision meetings 52 that serve to keep the project moving and on schedule. In short, during the strategic planning process 54, a roadmap is created for using operations that better utilize information technology. Often during the planning processes, organizations rush to evaluate vendor functionality without first building a shared organizational goal and without understanding the organization's ability to reengineer processes to take advantage of technology.

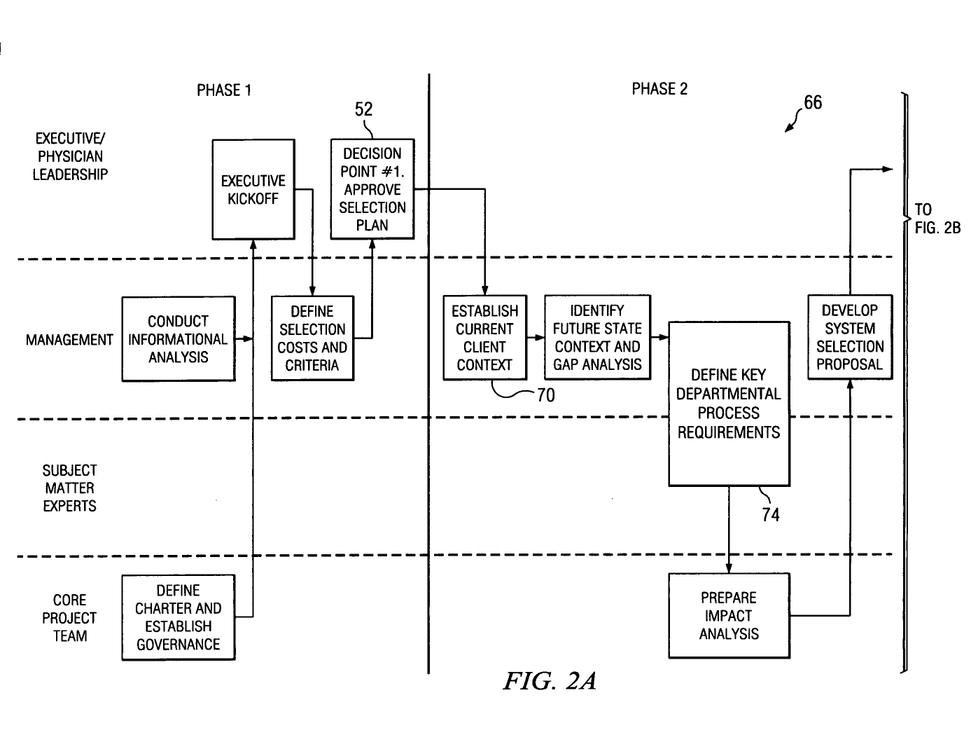

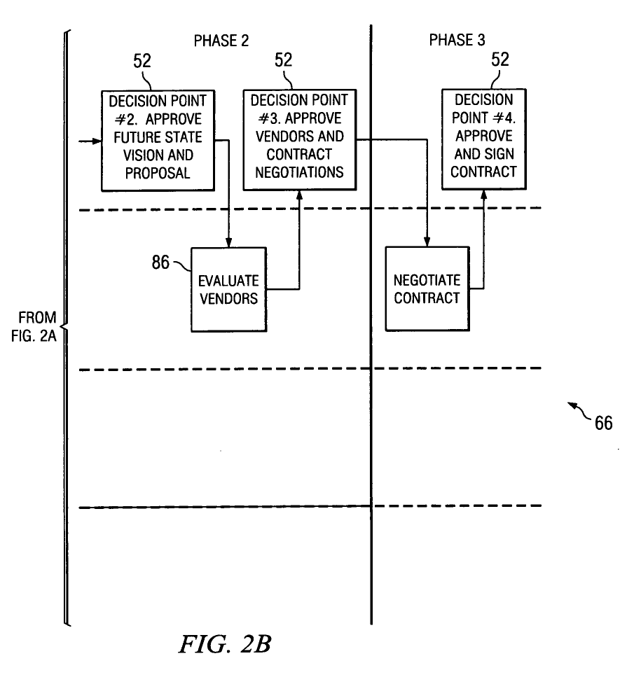

Referring to FIG. 2, a system selection process 66 in accordance with one embodiment of the present invention is shown. In this example, at block 70, the current states of selected processes are identified. This step allows metrics and other data to be collected for processes that are under consideration and then later compared with future states, after changes to processes and/or technology have been made. In other words, a before and after picture may be obtained to evaluate the effectiveness of a technology project.

At block 74, departmental process requirements are defined. As opposed to other methods that focus primarily on technology, the present invention utilizes a process-driven approach that includes evaluating different operational process flows. In one illustrative embodiment, a process flow database is created that includes process flows for a multitude of standard process flows used in healthcare environments. One example of such a database is the ProMap4 propriety database marketed by Healthlink Inc.

The process flow database may include operational process flows that represent “best practices maps” for common health care processes. The database may also include vendor workflows that represent the specific functionality and process maps of the healthcare industry's biggest software providers. For example, the database may include process flows for core clinical systems, departmental and ancillary systems, financial and billing systems, ERP and administrative systems. The process flow database may also include solution-oriented selection services, such as computerized physician order entry, closed loop medication management, integrated supply chain solutions, and integrated PACS/RIS solutions.

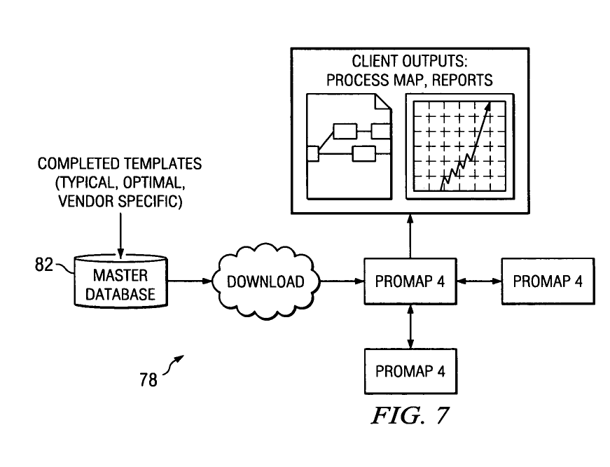

Referring to FIG. 7, an illustrative process flow database 78 is shown. In this example, a master database 82 stores completed templates, such as typical process flows, optimal process flows, and vendor specific process flows.

The master database 82 may include a server running SQL Server 2000 and may be accessible by client terminals over a virtual private network. Client computers may access the master database 82 using a framework application such as Visual Basic. The process flow database 78 allows templates to be downloaded, which may be used to generate process maps, reports, etc. Moreover, the process flow database 78 may be used to modify or create process maps, vendor workflows, and application specific maps, all of which may be stored in the master database 82.

Referring back to FIG. 2, at block 86, the process flow database 78 is used with the system selection process 66 to eliminate or include specific vendors for a particular technology project. Vendor software applications may or may not support best practices. In general, it is impractical to customize and maintain technology to support best practices. Therefore, during the system selection process 66, the process flow database 78 may be used to recognize the limitations and capabilities of vendor solutions. The process flow database 78 may also be used to understand how specific vendor applications react to different operational scenarios. Moreover, the process flow database 78 may be used to select vendor solutions that are best aligned with certain operational processes. The process flow database 78 expedites this analytical process by providing the ability to quickly recall and visualize stored operational process flows. Because it is difficult for vendor workflows to exactly match best practice maps, it may be necessary to adopt changes to the operational process to achieve the maximum attainable business result from the selected technology.

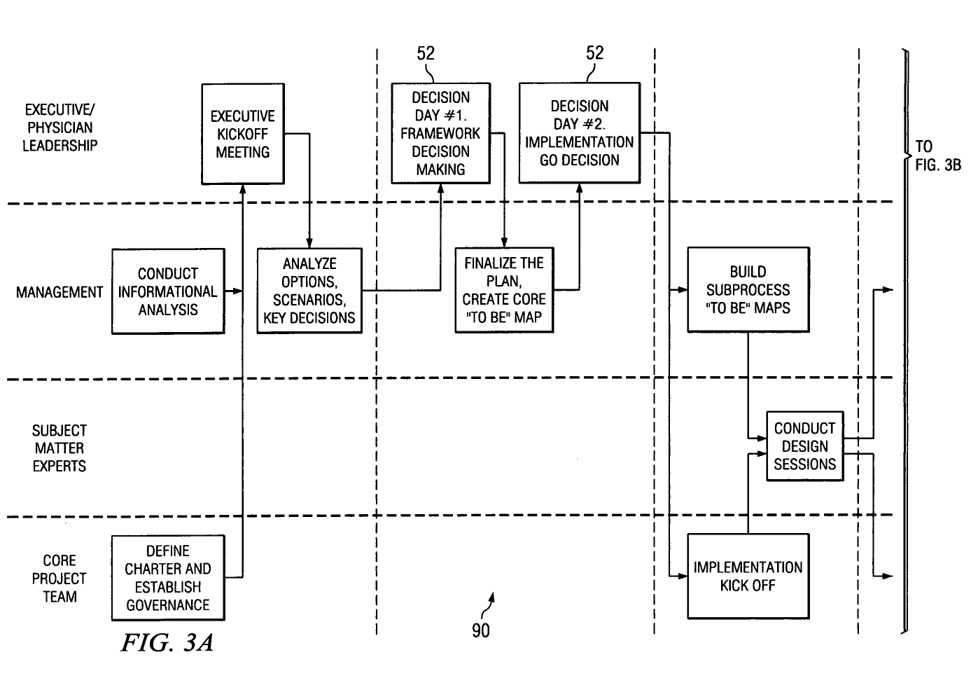

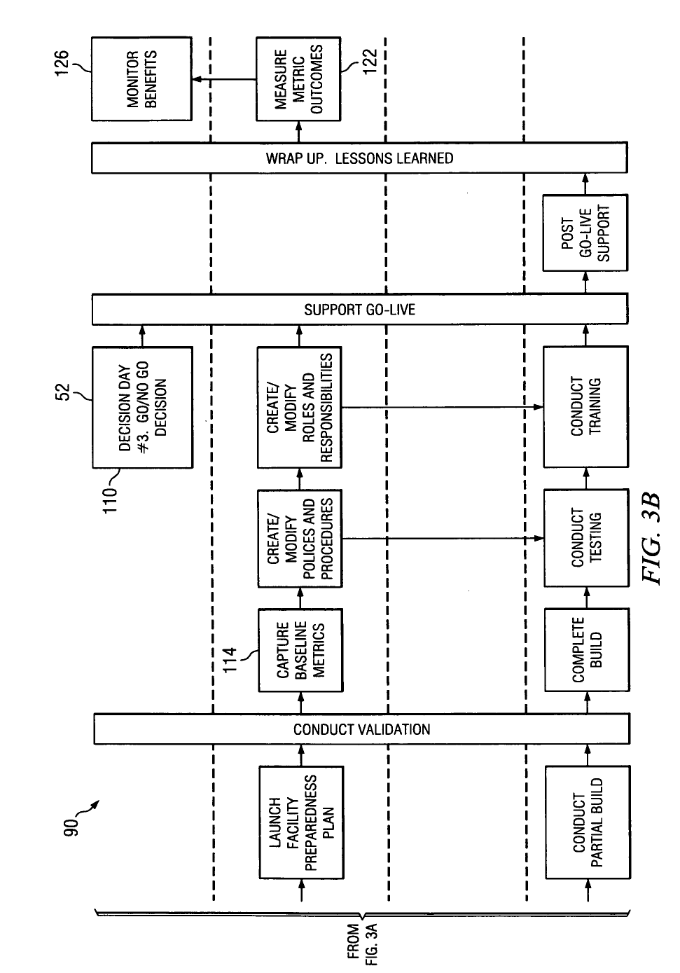

Referring to FIG. 3, an implementation process 90 in accordance with one illustrative embodiment of the present invention is shown. As shown, the implementation process 90 continues to use decision meetings 52. One component of a successful implementation is a governance structure that empowers multiple levels within an organization to participate in the decision making process.

Operational metrics, such as performance measurements, project related measurable outcomes, etc, are used to evaluate the effectiveness of a technology project. The present invention incorporates operational metrics at different intervals during a technology project. The type of metrics to be considered are ordinarily determined prior to the beginning of a new technology project and then measured and monitored throughout and after completion of the project.

In one embodiment of the present invention a metric database is utilized that includes information relevant to technology projects undertaken in healthcare environments. The metric database may include information to assist in the decision making process (i.e., during decision meetings 52). The metric database may include case studies, benchmarks, return on investment (ROI) studies, research articles, best practices information, and other benefits realization studies. The metric database allows consultants, the governance group, or other decision makers easier access to information relevant to a technology project. The information may be used to build business cases, identify realistic targets during the strategic planning process, etc. In the past, this research was completed using manual processes that required a considerable time investment.

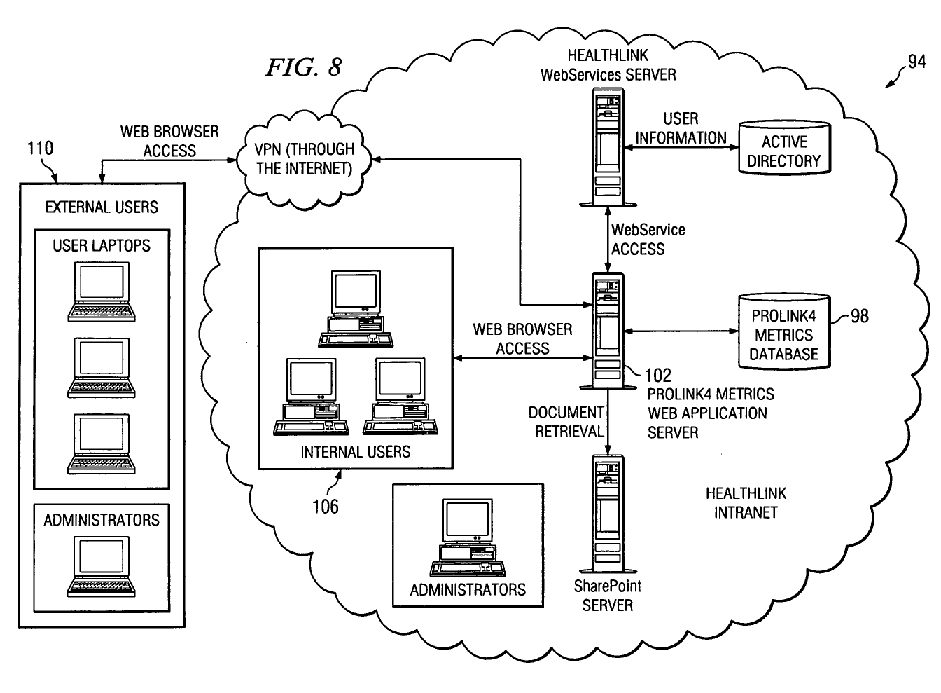

Referring to FIG. 8, an exemplary metric database 94 is shown. Such a system may include the ProLink4 metrics software tool distributed by Healthlink Inc. In this example, a metrics database 98 is coupled to a web application server 102. The metrics database 98 may use SQL Server 2000, and the web application server 102 allows internal and external users 106, 110 restricted access to the data stored in the metrics database 98.

Referring back to FIG. 3, performance metrics may be utilized during the implementation process 90 to evaluate the success of a technology project. At block 114, baseline metric data is captured after the implementation is validated. This data may be used by the governance group, at block 118, to decide whether to go “live” with the implementation. If and when the system is fully implemented, at block 122, metric data may be measured and used by the governance group, at block 126, to monitor the benefits obtained (e.g., reduced patient wait time, cost savings, reduced employment staff, etc.) post-implementation. This data may be compared with and evaluated using the metric database 94. As shown, decision meetings are used throughout the implementation process 90.

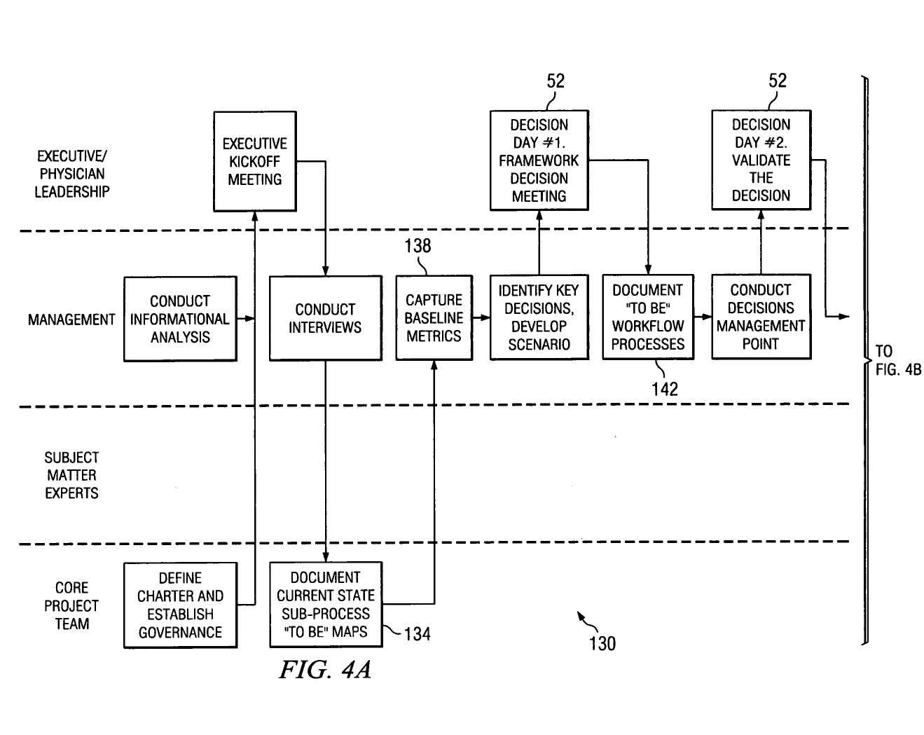

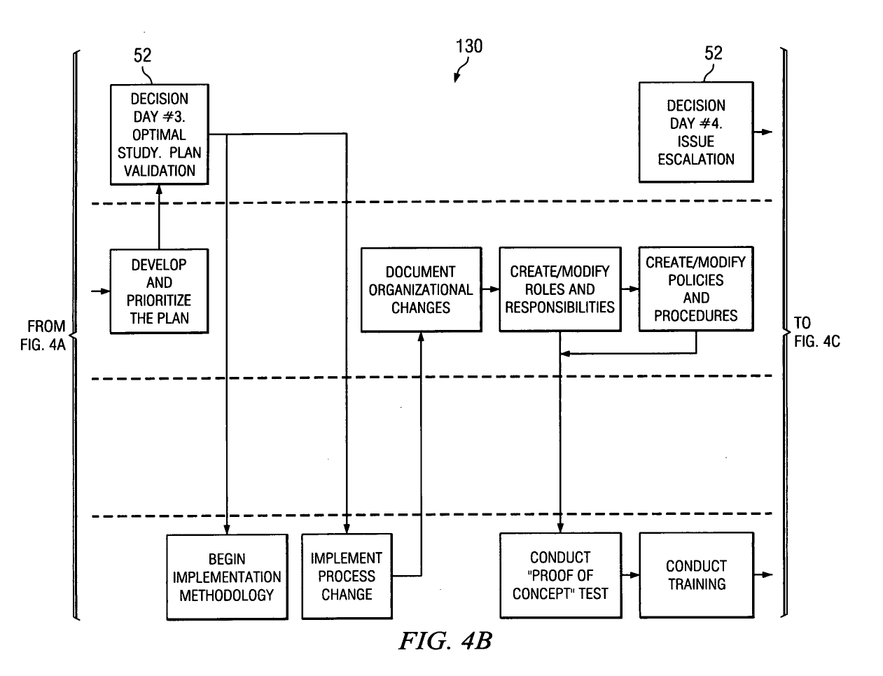

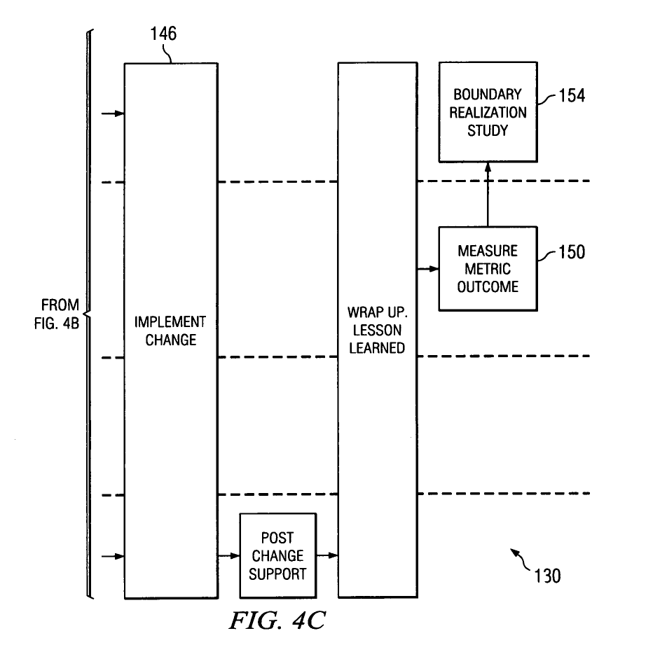

Referring to FIG. 4, an optimization process 130 in accordance with one embodiment of the present invention is shown. With the optimization process 130, an existing system is modified to take advantage of unrealized capabilities. At block 134, the current state of the system is document, and at block 138, baseline metric data for the unmodified system is captured. This data may be compared with benchmark data in the metric database 94, to determine if the system is being fully utilized.

The process flow database 78 may be used to examine best practice processes. The process flows stored in the process flow database 78 may be evaluated in conjunction with metric data available in the metric database, so that at block 142 a workflow process may be developed to improve the existing system. As shown, the governance group continues to be involved via decision meetings 52 to keep the technology project moving toward the desired goal. At block 146, a change to the existing system is implemented, and at block 150 metric data is measured so that at block 154 the governance group may evaluate the effectiveness of the change.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g., read only memory devices within a computer such as ROMs or CD-ROM disks readable only by a computer I/O attachment); (b) information alterably stored on writeable storage media (e.g., floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
identifying and prioritizing goals and objectives for an information technology project in a healthcare environment;
selecting a governance group to serve as a decision maker throughout the technology project;
using the identified and prioritized goals as a basis for developing a project plan and deciding upon desired outcomes for the technology project;
associating predefined process flows with the project plan;
presenting optimal scenarios for the predefined process flows to the governance group at a decision meeting; and
deciding upon a process flow and implementing the project plan.
